(19) United States
(12) Patent Application Publication
(10) Pub. No.: US 2016/0023136 A1
(43) Pub. Date: Jan. 28, 2016

(54) End Plug for Precoat Filter Element

(71) Applicant: Graver Technologies LLC, Glasgow, DE (US)

(72) Inventors: Brian Raab, Bel Air, MD (US); Brian Velon, Wilmington, DE (US)

(21) Appl. No.: 14/789,242

(22) Filed: Jul. 1, 2015

Related U.S. Application Data
(60) Provisional application No. 62/030,047, filed on Jul. 28, 2014.

(51) Int. Cl. B01D 29/07

(52) U.S. Cl. CPC B01D 29/07

(57) ABSTRACT

A precoat filtration element for a condensate polisher system that yields high weld strength in the form of a septa having a core with a plurality of perforations and wound filter elements, the wound filter elements wound around said core, and the septa including an extension flange at one end; and an end fitting having a solid base and a threaded post, the end fitting being slideably engaged within the extension flange such that an outside wall of the solid base is in mechanical contact with an inside wall of said extension flange, and upon insertion, the threaded post is coaxial with the septa center axis, and extends longitudinally outwards away from said septa. Spot welding the end fitting solid base to the extension flange provides high tensile strength over prior art designs.

### BACKGROUND OF THE INVENTION

1. Field of the Invention

The present invention relates to precoat-type filter elements or septa, and to a filtration system based on solid particulate filtration media, particularly, but not limited to, ion-exchange particulate filter media, and the like, supported on a septum. Such filtration systems, often known as “precoat filters” are widely used in a variety of applications. More specifically, the present invention relates to an end plug attachable to a septum's cylindrical body at each end.

2. Description of Related Art

Precoat filter units may be used in the chemical and refinery processing industry, the treatment of industrial waste, and the treatment of condensate boiler feed-water in fossil and nuclear steam generating systems. In particular, these filters are used where, after treatment, the liquid product must be very high in purity and closely adhere to specified standards of particulate, deionization, or chemical composition. Precoat-type filters are used, for example, in condensate polishing in fossil nuclear, and concentrated solar power plants. Precoat filtration systems, such as powdered precoat demineralizer systems, have been successfully used in condensate polishing technology for removing dissolved and suspended impurities from fluid streams in fossil and nuclear power generating facilities.

A precoat filter is a type of filter in which a slurry is applied as a cake, called a precoat, to the exterior of a porous support structure called a septum. After the precoat is applied to the septum, a fluid to be filtered is then directed through the precoat and the septum where the precoat serves to filter the fluid.

Precoat filtration uses a fine dispersion of a filter medium such as cellulose, carbon, or diatomite or powdered resin, which is deposited in a thin layer on a coarser carrier. A precoat filter element is a device designed to filter solid particles from a liquid-solid slurry after a precoat of built up solid material (filter aid or filtered solid) has been applied to the inner surface of the filter medium,

The predominant force keeping the precoat material on the element is flow, though rough, irregular surfaces help keep precoat material in place on the element surface. A continuously wound precoat element design ensures consistent differential pressures and, in turn, uniform precoats.

Currently, wound filter elements are constructed of polypropylene, nylon or carbon fiber yarn wound around a stainless steel core with stainless steel end fittings. Resins, such as Powdex®, are used with the filter. Powdex® is a powdered, strong acid or strongly basic hydroxide form of ion exchange resins. They may be used individually or as a mixture of both types. To ensure product consistency the elements are typically manufactured with computer controlled winding machines. These elements are available in a variety of end fittings for Powdex® systems, such as flanged doubled open ended, Sealfast™, or Ecoloc™ designs.

The wound Powdex® filter elements are available with suitable cores and end fittings.

The resin may be precoated on Aegis® wound and DualGuard® precoat septa in precoat filtration systems, by Graver Technologies LLC, which in some instances have been referred to as Powdex® filter demineralizers.

A particular example of water treatment requiring stringent quality control, and in which the use of precoated filters is common, is the polishing of condensed boiler steam in fossil or nuclear power plants. Two principal types of nuclear power plants are boiling water reactors (BWR) and pressurized water reactors (PWR). Though they use different processes for generating steam to drive turbines in producing electricity and require different water chemistry, both employ similar water purification systems commonly referred to as condensate polishers.

In boiling water reactors, should particles pass through the feedwater system and into the reactor, they may cause degradation and become radioactive. Should radioactive particles be created, they pose a costly disposal problem and may well present a threat of exposing personnel to radioactive materials. The presence of particulate contaminants in pressurized water reactors can cause stress cracks in heat exchanger tubes.

A condensate polisher, such as Powdex®, is a system used to remove impurities from turbine condensate before it is re-used for boiler feedwater. It combines the mechanical process of filtration with the chemical process of ion exchange to remove most impurities from turbine condensate. This filter element is typically a tubular string wound septum, coated with Powdex® ion exchange resin to remove impurities from a fluid stream.

Precoating is a process of applying a coating of material (precoat) to the outside of a septum so that the coating traps the impurities from a fluid stream instead of the septum. Once the filtration is performed over a period of time, the system is backwashed (cleaned) by reversing the fluid flow to remove impurities.

Unlike filter cartridges, where particle entrapment must be effected throughout the depth of the yarn winding filter medium, it is essential in precoat septum applications that no particle entrapment be effected within the body of the yarn winding. That is to say, in a cartridge filter, the cartridge is normally utilized until it becomes plugged or nearly plugged, and then it is discarded. Therefore, particle entrapment throughout the entire depth of the filter medium is essential to optimize the filter's usefulness. In the case of the precoat septa, however, backflushing is an essential requirement so that the device can be cleaned and reused over and over again. Ideally, therefore, particle entrapment within the depths of the winding is not desired, since particles entrapped within the depth do not flush out effectively. Accordingly, the yarn winding on a precoat septum is preferably wound to assure a tighter pore size, particularly on the surface of the winding, to prevent particulate matter from entering the depth of the yarn winding.

Filter/Demineralizer systems have the capabilities of removing both dissolved and suspended impurities. This is usually achieved by the processes of filtration and ion exchange, but can also combine the processes of adsorption and absorption.

Precoat filter demineralizers combine superior filtration, compared to deep bed polishers, with kinetically superior ion exchange by using finely ground, highly regenerated resins precoated onto septa in pressure vessels that are specially designed to provide uniform precoat application and process flow distribution.

The standard of performance required in such highly demanding environments has come to indicate the use of a finely divided ion-exchange resin filtration system wherein the particulate filter medium is supported on a septum where it is intended to be retained by the flow stream of the liquid to be filtered.

A septa provides for strong, durable support for enhanced resin precoating/flow distribution and efficient, aggressive backwashing. Typically, septa are manufactured of stainless steel. Advanced, stainless steel backwashable precoat septa have been used for reactor water cleanup (RWCU), fuel pool, and other specialty applications in nuclear power generation. For example, Aegis® PowerGuard elements incorporate an advanced sintered metal design that allows for precise control of porosity (from 2 to 200 microns). Key features include low pressure drop; virtual elimination of contaminant leakage; high strength; excellent resistance to corrosion and fatigue; collapse strengths over 400 psid; low carbon 316L, stainless steel construction; operating temperatures up to 1000° F.; and excellent cleaning and precoating characteristics.

The septa include end plugs for attachment. Currently, manufacture of the septa, including the end plug, and the subsequent attachment of the end plug to the septa, uses a labor and tooling intensive multistage process. Problems in the prior art with attachment of the end plug include lower than acceptable weld strength during spot welding. This affects the overall attachment strength, durability, and longevity of the end plug/septa combination.

Attempts to provide a stronger spot weld to attach an end plug to the septa cylindrical body have included introducing different weld recipes to the prior art end plug design; however, these iterations failed to achieve the high strength, easy, manufacturability, and extended durability desired.

Although it is counter-intuitive to implement an end plug having a solid base, especially for enhancing a welded joint, the advantage realized by the present invention of having a stronger precoat filtration element connection end plug allows for an extended life for a filter element constantly subjected to contaminants, and numerous backflushing forces.

### SUMMARY OF THE INVENTION

Bearing in mind the problems and deficiencies of the prior art, it is therefore an object of the present invention to provide an end plug for a precoat filtration element that provides for a more secure attachment to a septa, and a stronger weld junction.

It is another object of the present invention to provide an end plug for a precoat filtration element that facilitates an improved spot welding attachment scheme.

The above and other objects, which will be apparent to those skilled in the art, are achieved in the present invention which is directed to a precoat filtration element comprising: a septa having a core with a plurality of perforations and wound filter elements, the wound filter elements wound around the core, the septa including an extension flange at one end; and an end fitting comprising a solid base and a threaded post, the end fitting slideably engaged with the extension flange of the septa such that an outside wall of the solid base is in mechanical contact with an inside wall of the extension flange, and upon insertion, the threaded post is coaxial with the septa center axis, and extends longitudinally outwards away from the septa.

The septa may cylindrical in cross-section and the solid base of the end fitting comprises a cylindrical block. The solid base is preferably spot welded to the extension flange.

The wound filter elements include polypropylene, nylon, carbon, polyester, or glass fiber yarn wound around the septa. The septa and the end fitting may comprise stainless steel.

A fine dispersion of a filter medium of cellulose, diatomite, or powdered resin may be deposited in a thin layer on the wound filter elements. The wound filter elements are wound to realize a tighter pore size on an outside surface to prevent particulate matter from entering the depth of the wound filter element winding. The fine dispersion of the filter medium may include divided ion-exchange resin.

A median maximum load of a welded end fitting/septa combination between the solid base and the extension flange is preferably greater than 2000 foot-pounds. A median extension of the welded end fitting/septa combination is preferably about less than 0.30 inches.

The extension flange may be cylindrical with a diameter greater than the end fitting solid base diameter.

The solid base and the threaded post may be machined from a single block and are integral with one another.

In a second aspect, the present invention is directed to an end plug for a precoat filtration element comprising a solid cylindrical base having an outside diameter and a center axis, and a threaded post coaxial with the solid cylindrical base center axis.

In a third aspect, the present invention is directed to a method of making a precoat filtration element comprising: providing a cylindrical, perforated septa having an extension flange at one end; winding the septa with a wound filter element; treating the filter media with a fine dispersion of a filter medium of cellulose, diatomite, or powdered resin deposited in a thin layer on the wound filter element; inserting a solid cylindrical base of an end plug within the extension flange; and spot welding the solid cylindrical base of the end plug to the extension flange, such that a median maximum load of the spot welded end plug/septa combination between the end plug solid base and the extension flange is greater than 2000 foot-pounds.

In a fourth aspect, the present invention is directed to a condensate polisher system for removing impurities from a turbine condensate before re-use for boiler feedwater, including: a steam generator in fluid communication with a turbine at one communication point and a filter/demineralizer element at a second communication point, the filter/demineralizer element including a plurality of precoat filter elements in fluid communication with a condensate pump, a condenser, and a hotwell, each of the filter/demineralizer elements comprising: a septa having a core with a plurality of perforations and wound filter elements, the wound filter elements wound around the core, the septa including an extension flange at one end; and an end fitting comprising a solid base and a threaded post, the end fitting slideably engaged with the extension flange of the septa such that an outside wall of the solid base is in mechanical contact with an inside wall of the extension flange, and upon insertion, the threaded post is coaxial with the septa center axis, and extends longitudinally outwards away from the septa; wherein the condensate polisher system combines a mechanical process of filtration with a chemical process of ion exchange to remove impurities from the turbine condensate.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a partial cross-sectional view of a precoat filter element having a perforated septa core terminated by an attachment end plug;

FIG. 2 depicts a cross-sectional view of the end plug of FIG. 1;

FIG. 3 depicts a top view of end plug of FIG. 1 with a centered threaded post;

FIG. 4 depicts a standard spot weld arrangement;

FIG. 5 depicts a cross-sectional diagram of a spot weld apparatus welding the cup-shaped end plug of FIG. 3 to cylindrical flanges of a septa;

FIG. 6 depicts a graph of tensile data for a spot welded cup-shaped top fitting end plug for a precoat filtration element;

FIG. 7 depicts an embodiment of the end plug of the present invention;

FIG. 8 depicts a partial cross-sectional view of the end plug of FIG. 7 attached to a septa;

FIG. 9 depicts a graph of tensile data for a spot welded top fitting end plug of the present invention for a precoat filtration element.

FIG. 10 depicts a cross-sectional diagram of a spot weld apparatus welding end plug to a septa, and more specifically to a flange extension of the septa; and

FIG. 11 depicts a filter/demineralizer configuration for condensate polishing utilizing a precoat filtration element having the end plug of the present invention.

### DESCRIPTION OF THE PREFERRED EMBODIMENTS

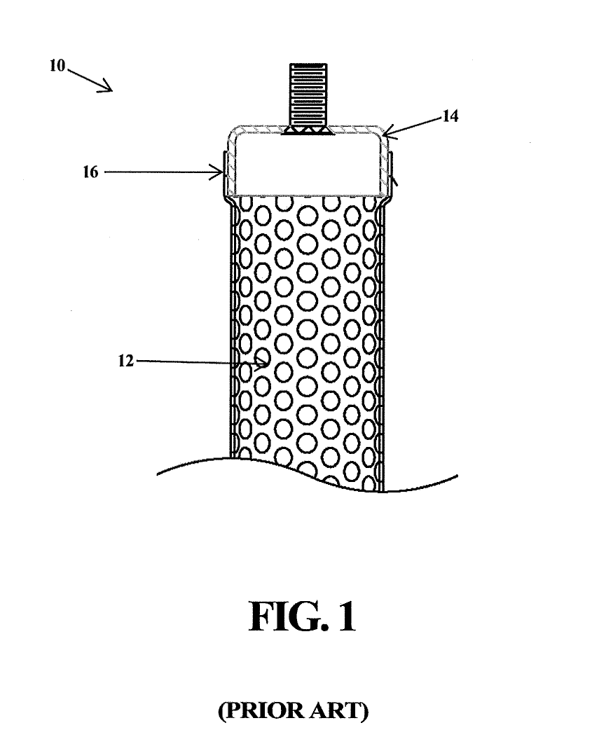

In describing the preferred embodiment of the present invention, reference will be made herein to FIGS. 1-11 of the drawings in which like numerals refer to like features of the invention.

FIG. 1 depicts a partial cross-sectional view of precoat filter 10 having a perforated septa core 12 terminated by an attachment end plug 14 of the prior art. End plug 14 is inserted within an extended cylindrical flange 16, which extends longitudinally from the cylindrical body of septa core 12, and spot welded in place.

Resistive spot welding (RSW) is a process in which contacting metal surfaces are joined by the heat obtained from resistance to electric current. Work-pieces are held together under pressure exerted by electrodes. Typically the sheets are in the 0.5 to 3 mm (0.020 to 0.118 in) thickness range. The process generally requires two shaped copper alloy electrodes to concentrate welding current into a small “spot” and to simultaneously clamp the sheets together. Forcing a large current through the spot will melt the metal and form the weld. Additional weld material may also be placed at the spot welding point. The attractive feature of spot welding is that a lot of energy can be delivered to the spot in a very short time (approximately 10-100 milliseconds). That permits the welding to occur without excessive heating of the remainder of the sheet.

The amount of heat (energy) delivered to the spot is determined by the resistance between the electrodes and the magnitude and duration of the current. The amount of energy is chosen to match the sheet's material properties, its thickness, and type of electrodes.

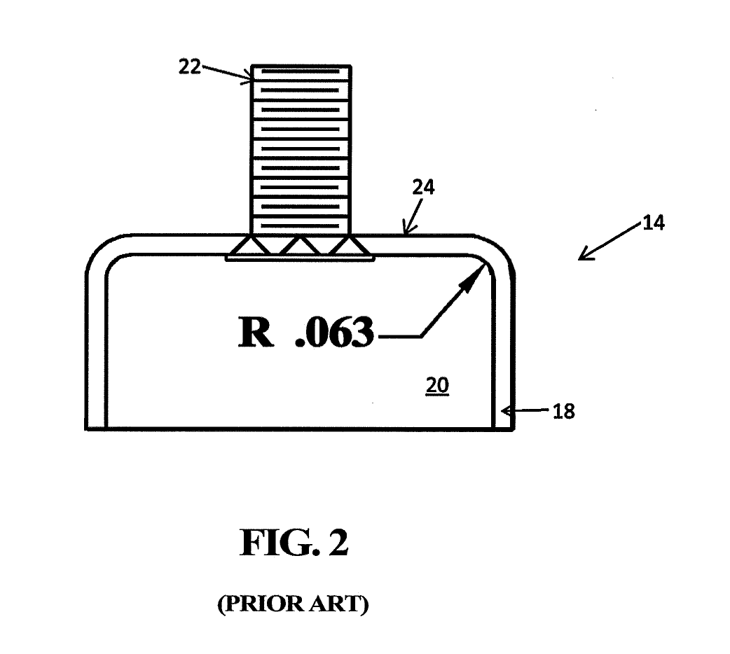

FIG. 2 depicts a cross-sectional view of the prior art end plug 14 of FIG. 1. Referring to FIG. 2, end plug 14 comprises a body portion 18 that defines a hollow, cup-shaped, cylindrical body forming a void 20 facing (for the purposes of directionality only) downwards. Upon attachment to septa 12, body portion 18 is axially aligned, such that body portion 18 is centered about septa 12. The outside wall of body portion 18 aligns longitudinally with the cylindrical body of septa core 12. Body portion 18 is designed to have an outside diameter that is less than the inside diameter of extended cylindrical flange 16, such that end plug 14 may be insertably attached to extended cylindrical flange 16 by weld, thread, friction fit, or the like. Currently, it is advantageous from the standpoint of strength and reliability to weld end plug 14 to the extended cylindrical flange 16 of septa core 12 by a spot welding technique. The present invention enhances the strength of the weld, and facilitates manufacturability of the connection.

Extending from the base of body portion 18 is a threaded post 22 used to attach the precoat filter to other segments of the filtration system. Threaded post 22 is radially centered about the base of body portion 18, and extends in a direction opposite the open end of body portion 18.

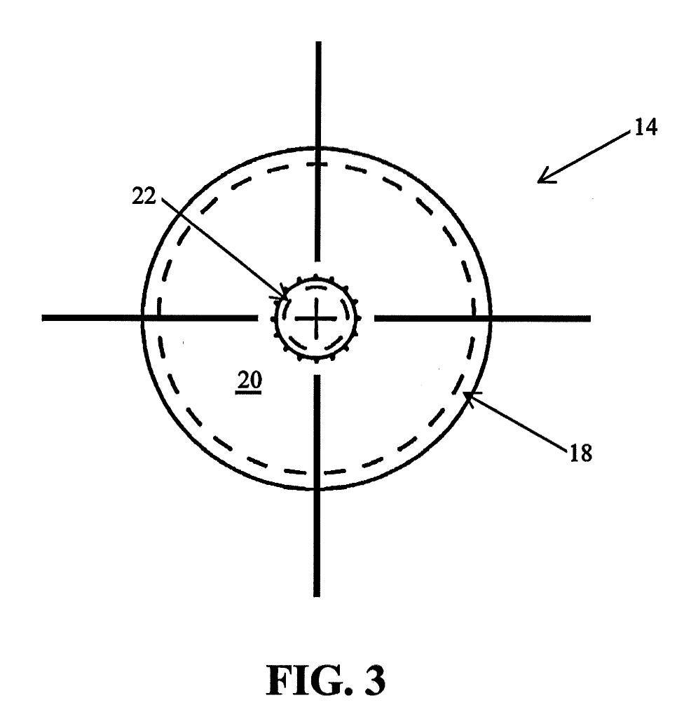

FIG. 3 depicts a top view of end plug 14 with centered threaded post 22.

Initially, to manufacture an end plug, wound rolls of stainless are fed into a stamping press over custom tooling to blank the body of the component. In this manner, the stamped end plug is “cup shaped” forming body portion 18 and void 20. A second step and fixture are used to provide a hole for threaded post 22. Threaded post 22 is then inserted within the hole, and resistance welded in a third fixture, forming the final end plug depicted in FIG. 2.

The final component is a stamped, down-facing cup that in certain applications preferably has an outer diameter of approximately 1.085 inches, a wall height of approximately 0.50 inches, and a wall thickness of about 0.050 inches, with a ¼-20 threaded post 22 sticking out of the top surface of the cup. The longitudinal axis of threaded post 22 is perpendicular to the top surface 24 of body portion 18.

The end plug is then spot welded to the cylindrical flanges 16 of septa 12.

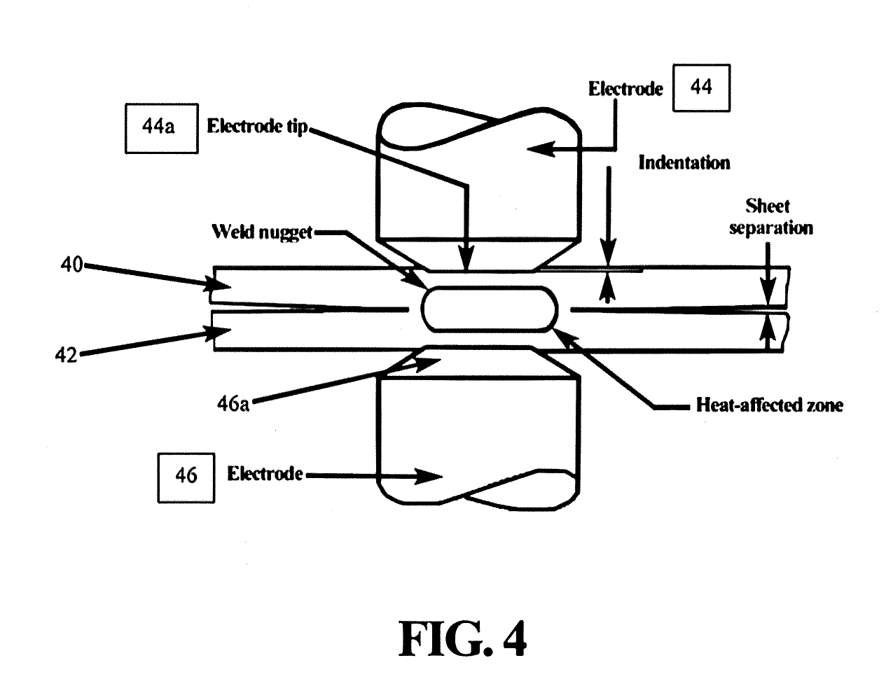

FIG. 4 depicts a standard spot weld arrangement. Spot welding typically sandwiches two pieces of material 40, 42 between two electrodes 44, 46 having electrode tips 44a, 46a respectively. Spot welding usually requires current flow through a certain number of layers, and does not utilize a center plug, which reduces resistance—the key ingredient to a spot weld.

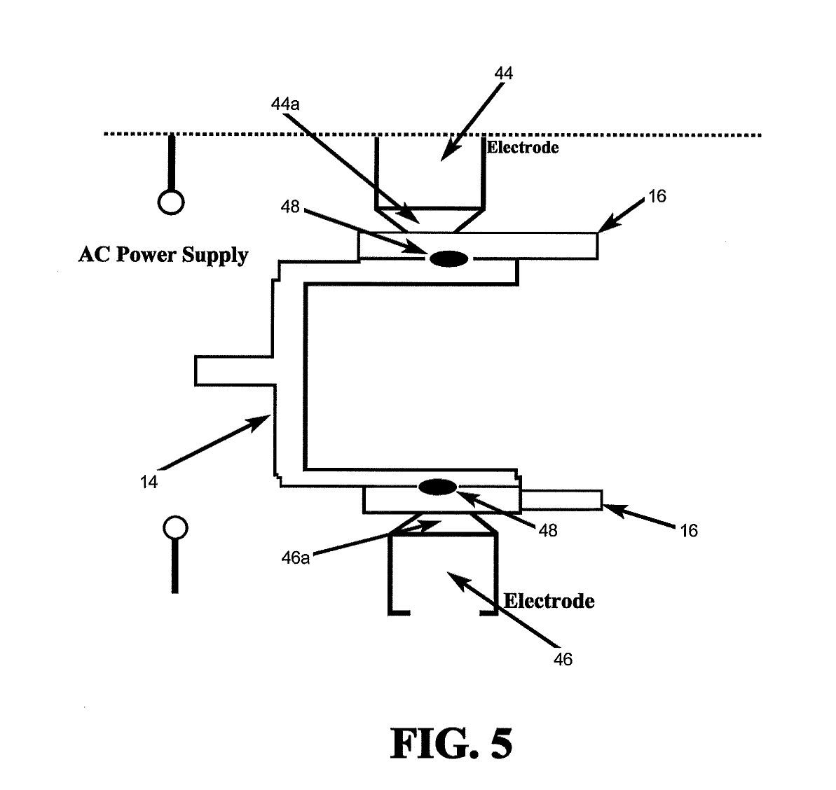

FIG. 5 depicts a cross-sectional diagram of a spot weld apparatus welding the cup-shaped end plug 14 to septa cylindrical flanges 16. Electrodes 44, 46 and electrode tips 44a, 46a contact diametrically opposed points on cylindrical flanges 16 once end plug 14 is slideably inserted within flanges 16. A weld point 48 is formed at each point aligned with electrode tips 44a, 46a, respectively.

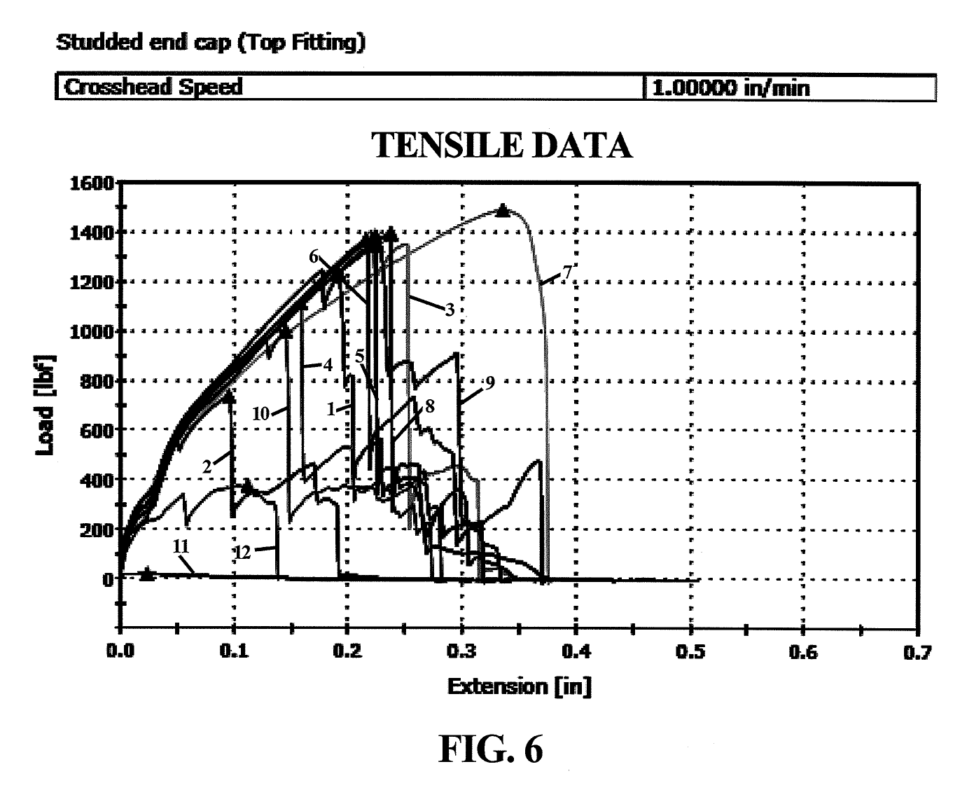

FIG. 6 depicts a graph of tensile data for a spot welded cup-shaped top fitting end plug for a precoat filtration element. Each curve 1-12 represents a different specimen. The load in foot-pounds denoted by the ordinate (Y-) axis is graphed against the measured extension in inches, denoted by the abscissa (X-) axis. Maximum loads and maximum extensions are recorded in Table 1.

TABLE I

| | | Maximum | Extension at |
|---|---|---|---|
| | Specimen | Load | Maximum Load |
| | label | [lbf] | [in] |
| 1 | A | 1349.2 | 0.23 |
| 2 | B | 739.9 | 0.10 |
| 3 | C | 1366.2 | 0.22 |
| 4 | D | 1113.3 | 0.16 |
| 5 | E | 1383.8 | 0.23 |
| 6 | F | 1372.6 | 0.22 |
| 7 | G | 1490.8 | 0.14 |
| 8 | H | 1398.5 | 0.16 |
| 9 | J | 1334.5 | 0.18 |
| 10 | K | 1003.9 | 0.15 |
| Maximum | | 1490.8 | 0.34 |
| Minimum | | 739.3 | 0.20 |
| Median | | 1244.9 | 0.20 |

As shown, the maximum load recorded was 1490.8 foot-pounds, and the corresponding extension at maximum load was 0.34 inches. On average, the median maximum load of the twelve specimens was 1244.9 foot-pounds, and the median extension recorded was 0.20 inches.

In order to enhance the strength of the welded junction, the proposed new generation end plug is machined from round stock in the form of a monolithic one piece solid cylinder, having an outer diameter, for example, of 1.085 inches, a height of approximately 0.5 inches, with a ¼-20 threaded post, which is preferably integral to the solid cylinder from which it is made.

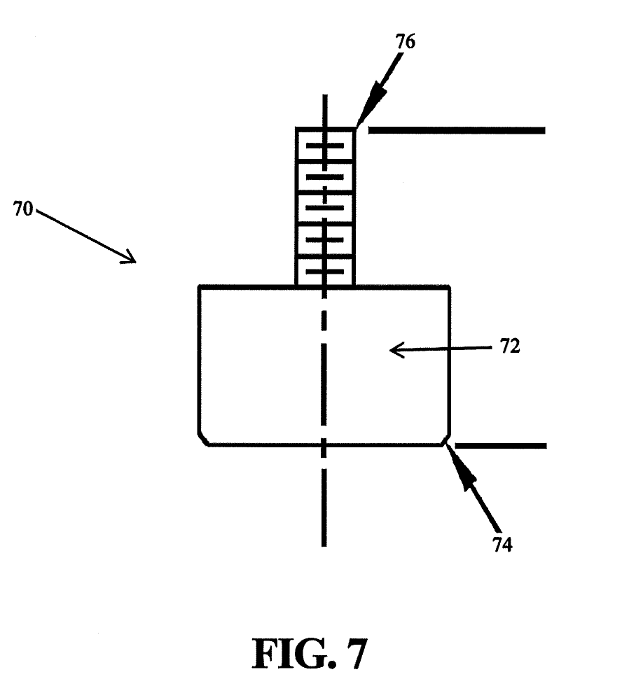

FIG. 7 depicts end plug 70 of the present invention. End plug 70 comprises a solid base in the form of a cylindrical block 72 having chamfered edges 74. This design adds weight to the end precoat filtration element, and presents a larger heat sink to the welding process, thus making for a counter-intuitive design enhancement; however, the weight gain is offset considerably by the advantages realized in facilitating a spot weld attachment, and the resultant increased weld strength.

Threaded post 76 is preferably a ¼-20 threaded post, axially centered about solid cylindrical block 72. In one embodiment, post 76 is machined from the same round stock that formed solid cylindrical block. In an alternative embodiment, threaded post 76 is attached to cylindrical block 72 by weld, threads, friction fit, or other attachment schemes known in the art suited for the adverse environments to which the precoat filtration element is exposed.

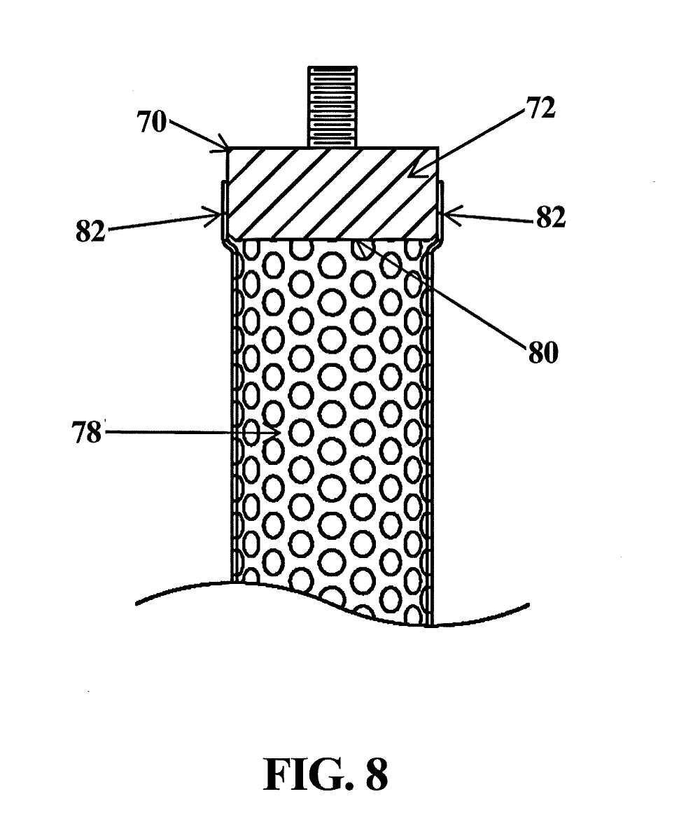

FIG. 8 depicts a partial cross-sectional view of end plug 70 of FIG. 7 attached to septa 78. Referring to FIG. 8, end plug 70 comprises cylindrical block 72 that defines a solid cylindrical body having a planar face 80 facing (for the purposes of directionality only) downwards. Upon attachment to septa 78, cylindrical block 72 is axially aligned with, and is centered about, and coaxial with, septa 78. The outside wall of cylindrical block 72 may either be the same diameter as the outside diameter as the septa, or may extend slightly beyond the longitudinal cylindrical walls of septa 78; that is, cylindrical block 72 may have a larger diameter than septa 78 or be the same diameter as septa 78. Septa 78 includes a flange extension 82 at its end. Flange extension 82 may be completely circular about septa 78, having a slightly larger diameter than the diameter of septa 78 to receive cylindrical block 72, or may be segmented extensions (not completely circumferential). Flange extension 82 extends parallel to the cylindrical walls of septa 78 in the longitudinal or axial direction and forms a larger diameter than the septa cylindrical walls to receive cylindrical block 72.

End plug 70 is insertably attached to flange extension 82 preferably by spot weld, but may also be attached by complementary threads, friction fit, or other attachment schemes known in the art. Currently, it is advantageous from the standpoint of strength and reliability to weld end plug 70 to flange extension 82 of septa 78 by a spot welding technique, and the present invention is designed to strengthen the welded joint by allowing for a more robust weld attachment.

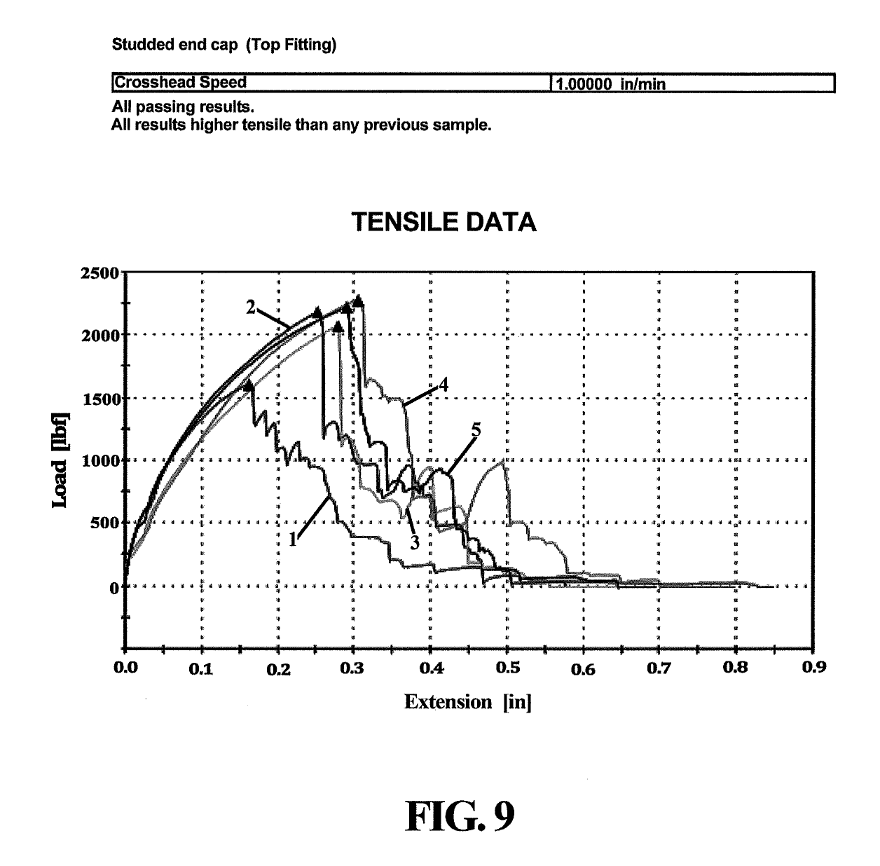

FIG. 9 depicts a graph of tensile data for a spot welded top fitting end plug of the present invention for a precoat filtration element. Each curve 1-5 represents a different specimen. The load in foot-pounds denoted by the ordinate (Y-) axis is graphed against the measured extension in inches, denoted by the abscissa (X-) axis. Maximum loads and maximum extensions are recorded in Table 2.

TABLE 2

| | | Maximum | Extension at |
|---|---|---|---|
| | Specimen | Load | Maximum Load |
| | label | [lbf] | [in] |
| 1 | 1 | 1604.3 | 0.16 |
| 2 | 2 | 2180.3 | 0.25 |
| 3 | 3 | 2065.8 | 0.28 |
| 4 | 4 | 2273.2 | 0.31 |
| 5 | 5 | 2217.7 | 0.29 |
| Maximum | | 2273.2 | 0.31 |
| Minimum | | 1604.3 | 0.16 |
| Median | | 2180.3 | 0.28 |

As shown, the maximum load recorded was 2273.2 foot-pounds, almost 800 foot-pounds greater than that realized by a cup-shaped end plug under the same spot welding conditions. The corresponding extension at maximum load was 0.31 inches. On average, the median maximum load of the five specimens was 2180.3 foot-pounds (an 800 foot-pound difference over the prior art), and the median extension recorded was 0.28 inches (only 8/100^{ths} of an inch greater than the prior art).

The minimum weld strength of the new generation end plug of the present invention was measured to be 6 to 8.5 times greater than that of the prior art. This comes at a cost of weight and weld current/time; however, given the remote location of these devices in a system, and the difficulty (and hazard) of replacing or repairing them, the benefits of using an end plug of the present invention in many instances outweigh the detriments of weight, cost, and weld time.

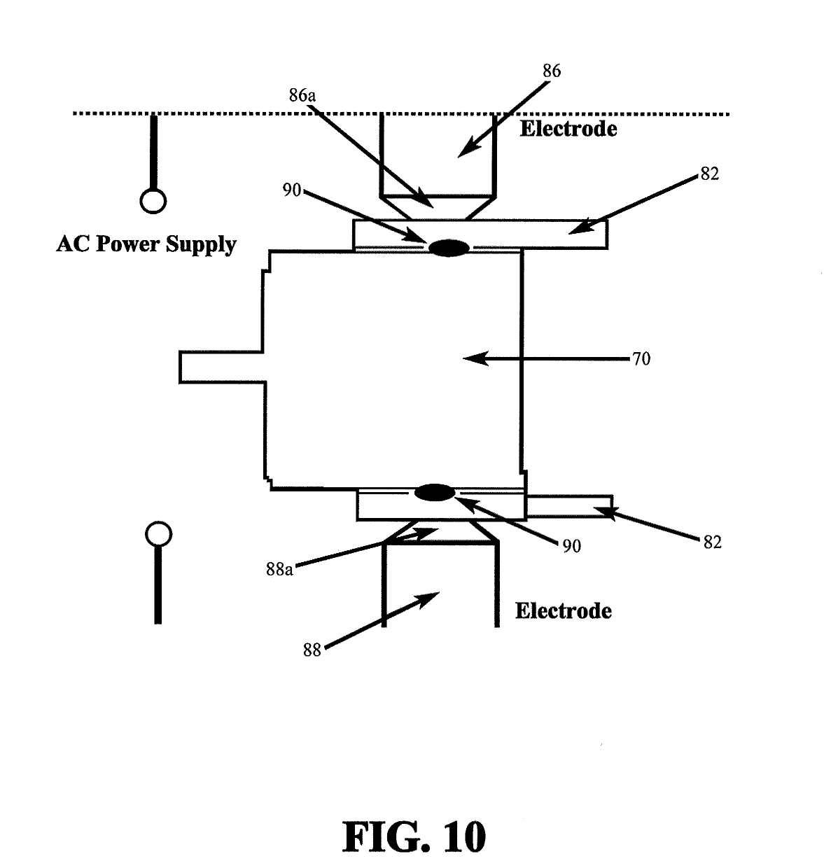

FIG. 10 depicts a cross-sectional diagram of a spot weld apparatus welding end plug 70 to septa 78 (of which only the septa's flange extension is shown), and more specifically to flange extension 82. Electrodes 86, 88 and electrode tips 86a, 88a respectively, contact diametrically opposed points on flange extension 82 once end plug 70 is slideably inserted within flange extension 82. A weld point 90 is formed at each point aligned with electrode tips 86a, 88a, respectively.

A precoat filtration element of the present invention is utilized in a condensate polisher system to remove impurities from, for example, a turbine condensate before it is re-used for boiler feedwater.

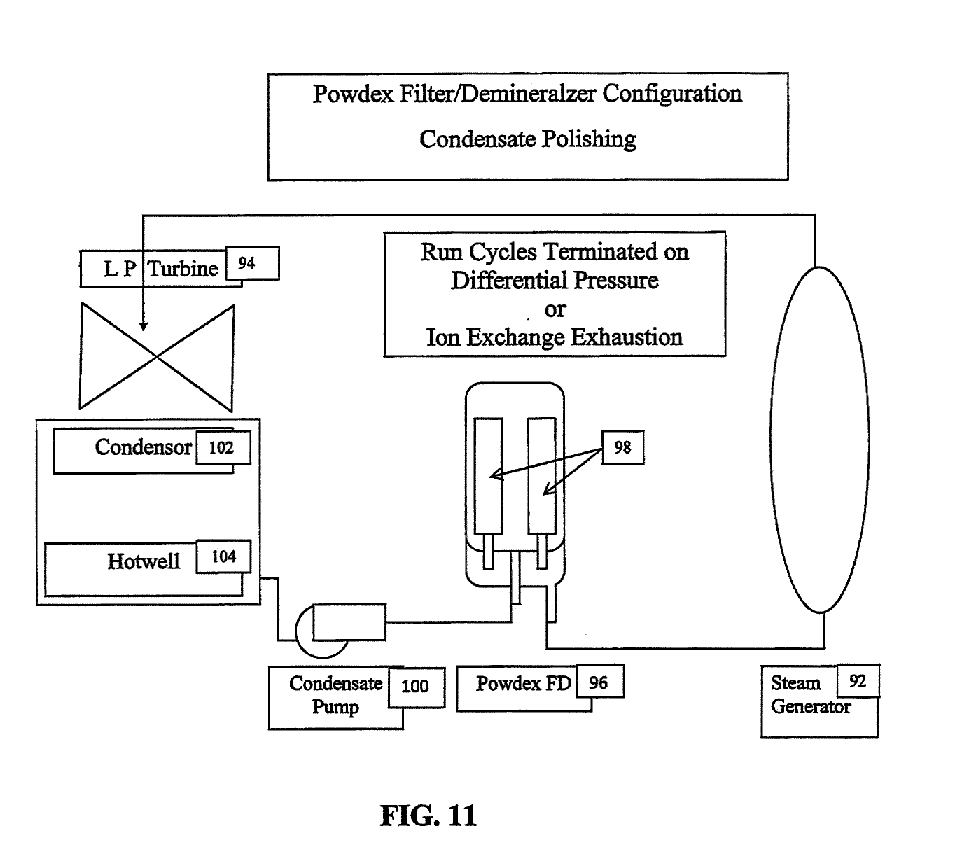

FIG. 11 depicts a filter/demineralizer configuration for condensate polishing. In this example, a steam generator 92 is in fluid communication with a turbine 94 at one communication point, and a filter/demineralizer configuration 96 at a second communication point. Filter/Demineralizer configuration 96 includes a plurality of precoat filter elements 98, which are in fluid communication with condensate pump 100, condenser 102, and hotwell 104. This condensate polisher combines the mechanical process of filtration with the chemical process of ion exchange to remove most impurities from the turbine condensate. Given the placement of the precoat filter elements, removal or repair would be costly, timely, and impractical. Consequently, it is advantageous for the design of the precoat filter element to be robust. Although contrary to prior art designs, and counter-intuitive to designs for simplifying welded joints in particular, the present invention's introduction of a solid, monolithic cylindrical block end plug presents a stronger welded bond that is far greater than that presented by prior art designs.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A precoat filtration element comprising:
a septa having a core with a plurality of perforations and wound filter elements, said wound filter elements wound around said core, said septa including an extension flange at one end; and
an end fitting comprising a monolithic, solid cylindrical base and a threaded post, said end fitting slideably engaged with said extension flange of said septa such that an outside wall of said solid base is in mechanical contact with an inside wall of said extension flange, and upon insertion, said threaded post is coaxial with said septa center axis, and extends longitudinally outwards away from said septa.

2. The precoat filtration element of claim 1 wherein said solid base is spot welded to said extension flange.

3. The precoat filtration element of claim 2 wherein said cylindrical base has an outer diameter of approximately one inch.

4. The precoat filtration element of claim 1 wherein said wound filter elements include polypropylene, nylon, carbon, polyester, or glass fiber yarn wound around said septa.

5. The precoat filtration element of claim 1 wherein said septa and said end fitting comprise stainless steel.

6. The precoat filtration element of claim 4 including a fine dispersion of a filter medium of cellulose, diatomite, or powdered resin deposited in a thin layer on said wound filter elements.

7. The precoat filtration element of claim 4 wherein said wound filter elements are wound to realize a tighter pore size on an outside surface to prevent particulate matter from entering the depth of said wound filter element winding.

8. The precoat filtration element of claim 6 wherein said fine dispersion of said filter medium includes divided ion-exchange resin.

9. The precoat filtration element of claim 3 wherein a median maximum load of a welded end fitting/septa combination between said solid base and said extension flange is equal to or greater than 2000 foot-pounds.

10. The precoat filtration element of claim 9 wherein a median extension of said welded end fitting/septa combination is approximately less than 0.30 inches.

11. The precoat filtration element of claim 1 wherein said extension flange is cylindrical with a diameter greater than said end fitting solid base diameter.

12. The precoat filtration element of claim 1 wherein said solid base and said threaded post are machined from a single block and are integral with one another.

13. An end plug for a precoat filtration element comprising a solid, monolithic cylindrical base having an outside diameter and a center axis, and a threaded post coaxial with said solid cylindrical base center axis.

14. The end plug of claim 13 comprising stainless steel.

15. The end plug of claim 13 wherein cylindrical base and said threaded post are machined from a single block and are integral with one another.

16. A method of making a precoat filtration element comprising:
providing a cylindrical, perforated septa having an extension flange at one end;
winding said septa with a wound filter element;
treating said filter media with a fine dispersion of a filter medium of cellulose, diatomite, or powdered resin deposited in a thin layer on said wound filter element;
inserting a solid cylindrical base of an end plug within said extension flange;
and spot welding said solid cylindrical base of said end plug to said extension flange, such that a median maximum load of said spot welded end plug/septa combination between said end plug solid base and said extension flange is greater than 2000 foot-pounds.

17. A condensate polisher system for removing impurities from a turbine condensate before re-use for boiler feedwater, including:
a steam generator in fluid communication with a turbine at one communication point and a fitter/demineralizer element at a second communication point, said filter/demineralizer element including a plurality of precoat filter elements in fluid communication with a condensate pump, a condenser, and a hotwell, each of said filter/demineralizer elements comprising:
a septa having a core with a plurality of perforations and wound filter elements, said wound filter elements wound around said core, said septa including an extension flange at one end; and
an end fitting comprising a solid, monolithic base and a threaded post, said end fitting slideably engaged with said extension flange of said septa such that an outside wall of said solid base is in mechanical contact with an inside wall of said extension flange, and upon insertion, said threaded post is coaxial with said septa center axis, and extends longitudinally outwards away from said septa, said end fitting and said extension flange welded together such that a median maximum load of a welded junction between said solid base and said extension flange is equal to or greater than 2000 foot-pounds; and
wherein said condensate polisher system combines a mechanical process of filtration with a chemical process of ion exchange to remove impurities from the turbine condensate.
